(19) United States
(12) Patent Application Publication
(10) Pub. No.: US 2026/0343253 A1
(43) Pub. Date: Oct. 29, 2026

(54) SYSTEMS AND METHODS FACILITATING ARTIFICIAL INTELLIGENCE (AI) DRIVEN DYNAMIC CONFIGURATION OF NETWORK NODES IN MOBILITY NETWORKS

(71) Applicant: AT&T Intellectual Property I, L.P., Atlanta, GA (US)

(72) Inventors: Yupeng Jia, South Pasadena, CA (US); Hongyan Lei, Plano, TX (US)

(73) Assignee: AT&T Intellectual Property I, L.P., Atlanta, GA (US)

(21) Appl. No.: 19/186,859

(22) Filed: Apr. 23, 2025

(51) Int. Cl. H04W 24/02; H04L 41/14

(52) U.S. Cl. CPC H04W 24/02; H04L 41/145

(57) ABSTRACT

Aspects of the subject disclosure may include, for example, configuring network nodes in a wireless mobility network based on a service trigger, facilitating communications among agentic artificial intelligence (AI) agents running in the network nodes, and dynamically assembling a necessary network node in the wireless mobility network to provide a service. Other embodiments are disclosed.

### FIELD OF THE DISCLOSURE

The subject disclosure relates to systems and methods facilitating artificial intelligence (AI) driven dynamic configuration of network nodes in mobility networks.

### BACKGROUND

The mobility network has been standardized to be labeled with different generation technologies and evolved to 5G and beyond. The network protocols are pre-defined by industry forums. The mobility products (user devices, Radio Access Network (RAN), a mobile network core) are implemented by strictly following predetermined protocols. Each message and each information element (IE) have to be implemented as defined in the standard. This static architecture and protocol may have conflicted with flexibility.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system in accordance with various aspects described herein.

FIG. 2C depicts an illustrative embodiment of a method in accordance with various aspects described herein.

FIG. 2D depicts an illustrative embodiment of another method in accordance with various aspects described herein.

FIG. 2E depicts an illustrative embodiment of further another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods facilitating artificial intelligence (AI) driven dynamic configuration of network nodes in mobility networks. The network architecture and network components are dynamically assembled or configured, instead of following pre-defined and static arrangements and protocols. The systems and methods utilize agentic AI agents to dynamically configure network nodes within the mobility network. These network nodes, which include devices, radio access networks (RAN), mobile core networks, transport layers, and applications, are driven by the agentic AI agents which engage in communications and coordination. The agentic AI agents communicate and take actions in response to various service triggers such as events, security, latency, and speed, to optimize resource allocation and enhance network efficiency. By facilitating communication between the agentic AI agents across different nodes, the systems and methods may provide a responsive and adaptive network environment that maximizes user experience and operational performance. Other embodiments are described in the subject disclosure.

One or more aspects of the subject disclosure are directed to a system including a processing system including a processor and a memory that stores executable instructions that, when executed by the processing system, facilitate performance of operations. The operations include facilitating communications among agentic artificial intelligence (AI) agents running in network nodes in a wireless mobility network; with the agentic AI agents, configuring one or more of the network nodes based on a service trigger, wherein the network nodes include user equipment, a radio access network (RAN), a mobile core network, a transport system, or a combination thereof; and coordinating an action responsive to the service trigger via the communications among the agentic AI agents.

One or more aspects of the subject disclosure are directed to a non-transitory machine-readable medium, comprising executable instructions that, when executed by a processing system including a processor, facilitate performance of operations. The operations comprise facilitating communications among agentic artificial intelligence (AI) agents in one or more network nodes in a wireless mobility network; receiving a service request and detecting a service type associated with the service request; with the agentic AI agents, dynamically assembling or configuring the one or more network nodes in the wireless mobility network based on the detected service type; coordinating an action based on the detected service type via the communications among the agentic AI agents; and upon completion of the action, rolling back a change made for the action by the agentic AI agents.

One or more aspects of the subject disclosure are directed to a method including dynamically configuring, by a processing system including a processor of an agentic artificial intelligence (AI) agent, a network node in a wireless mobility network based on a service request, wherein the network nodes include user equipment, a radio access network (RAN), a mobile core network, a transport system, or a combination thereof; facilitating, by the processing system, communications with other agentic artificial intelligence (AI) agents running in different network nodes in the wireless mobility network; and coordinating, by the processing system, a first action responsive to the service request via the communications with the other agentic AI agents.

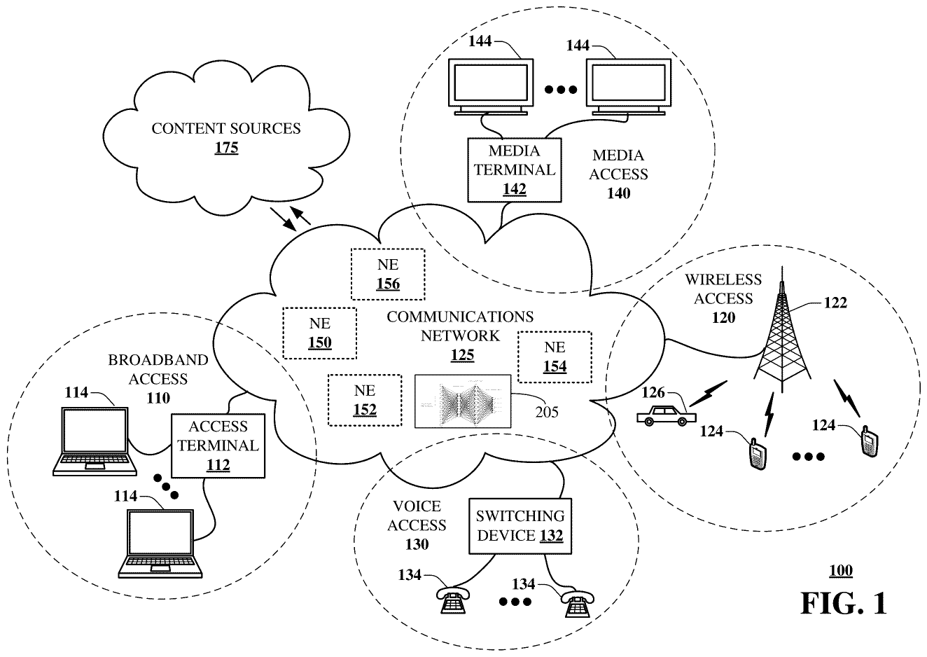

Referring now to FIG. 1, a block diagram is shown illustrating an example, non-limiting embodiment of a system 100 in accordance with various aspects described herein. For example, system 100 can facilitate in whole or in part systems and methods facilitating artificial intelligence (AI) driven dynamic configuration of network nodes in mobility networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, one or more agentic artificial intelligence (AI) agents 205 are distributed in the system 100. As depicted in FIG. 1, the agentic AI agents 205 are arranged in the communications network 125 which can communicate with other agentic AI agents arranged in other elements of the communications network 125. For instance, the agentic AI agents 205 can be arranged and used in the broadband access 110, wireless access 120, voice access 130, media access 140 and/or the distribution of content from content sources 175.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

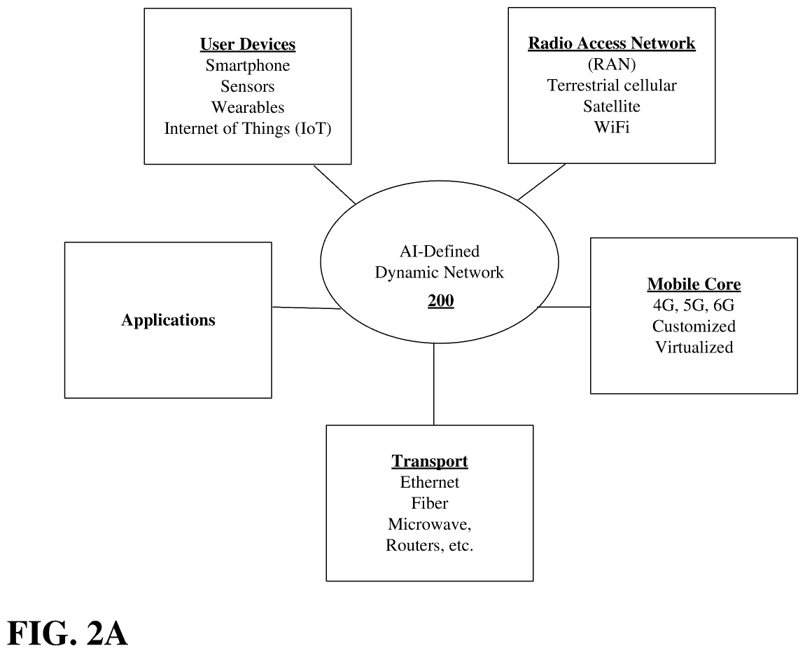

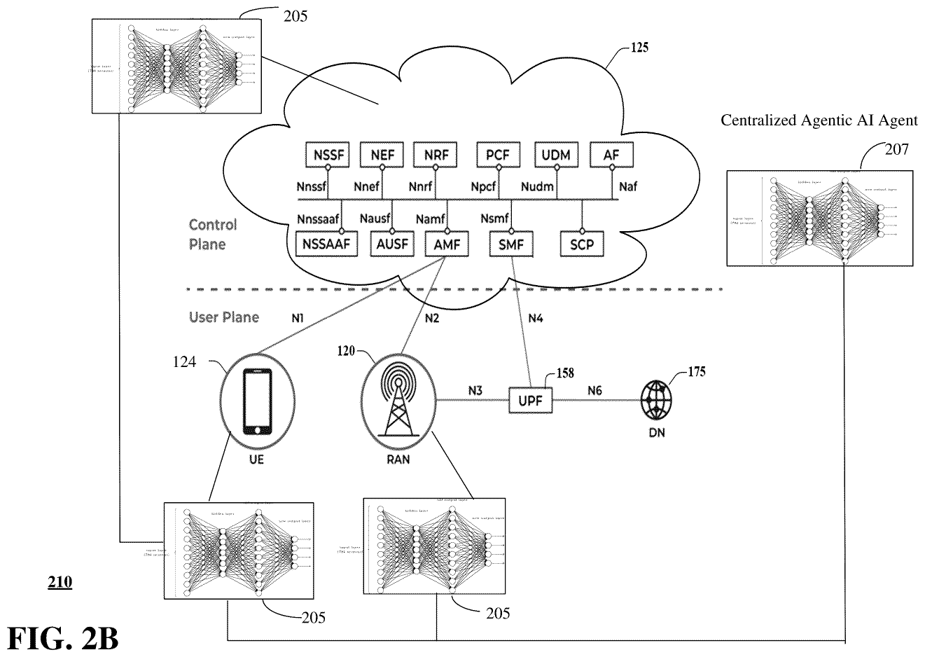

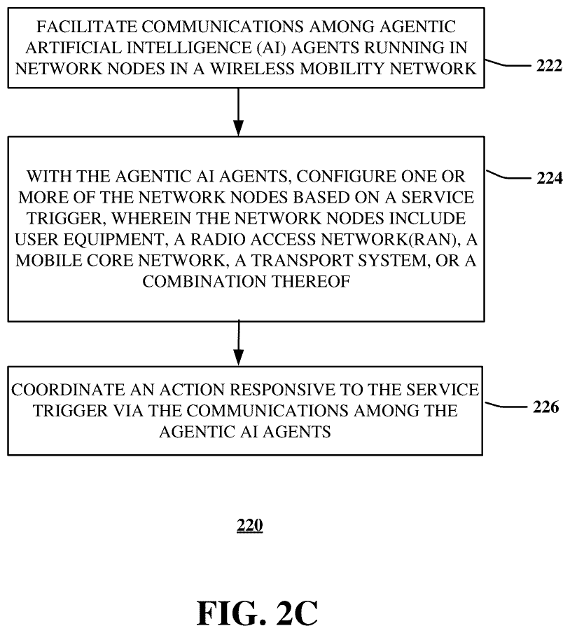

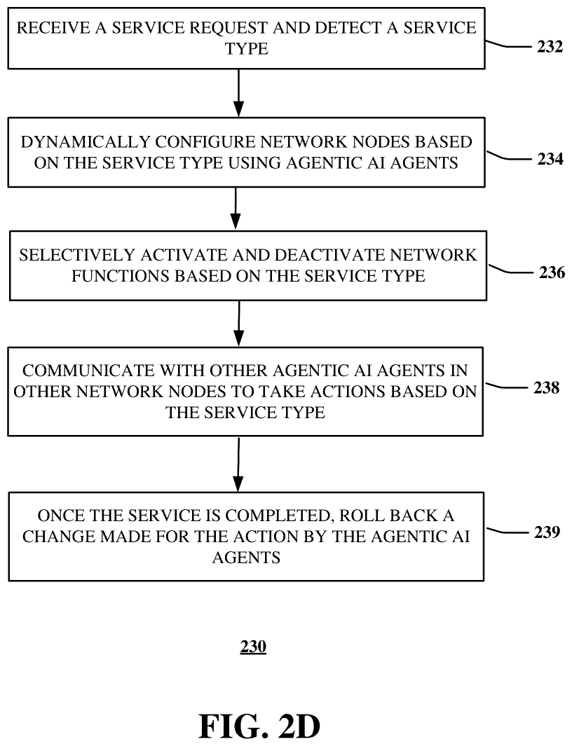

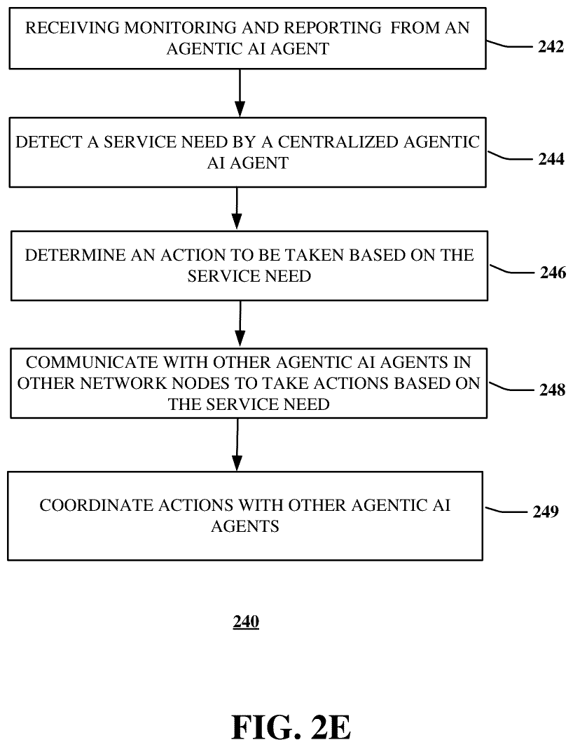

FIG. 2A is a block diagram illustrating an example, non-limiting embodiment of a system 200 functioning within the communication network of FIG. 1 in accordance with various aspects described herein. The system 200 is implemented in a wireless mobility network and includes various network nodes in the wireless mobility network. Various network nodes include user devices, radio access network (RAN), various applications, transport components, a mobile core, etc.

User devices in a wireless mobility network encompass a wide range of mobile and portable computing devices that facilitate communication and data exchange over the network. These devices include, but are not limited to, smartphones, tablets, e-readers, and phablets, which are commonly used for personal communication, internet browsing, and multimedia consumption. Additionally, user devices extend to wearables, such as smartwatches and fitness trackers, which provide health monitoring and connectivity features. The network also supports Internet of Things (IoT) devices, including sensors and smart home appliances, which communicate data for automation and monitoring purposes. These devices are equipped with wireless communication capabilities, enabling them to connect to the network via technologies such as 4G, 5G, Wi-Fi, and Bluetooth, thereby facilitating seamless mobility and access to a wide array of services and applications.

The RAN serves as a component that connects user devices to the core network, facilitating the transmission of voice, data, and multimedia services. The RAN is responsible for managing radio resources, ensuring efficient spectrum utilization, and maintaining seamless connectivity as users move across different geographical areas. The RAN comprises various elements, including base stations and access points, which can operate using different technologies such as terrestrial cellular networks (e.g., 4G, 5G), satellite communications, and Wi-Fi. These elements work together to provide robust and reliable wireless coverage, supporting a wide range of applications and services. The RAN's architecture is designed to be flexible and scalable, allowing it to adapt to varying network demands and technological advancements, thereby enhancing the overall user experience and network efficiency.

Various applications in the wireless mobility network encompass a diverse array of software and services that leverage the network's capabilities to deliver functionality to user devices. These applications can range from basic communication services, such as voice calls and messaging, to more complex services like video streaming, online gaming, and virtual reality experiences. Additionally, applications in a wireless mobility network include enterprise solutions, such as mobile workforce management, remote collaboration tools, and secure access to corporate resources.

The network also supports applications for Internet of Things (IoT) devices, enabling automation and monitoring in smart homes, industrial settings, and healthcare environments. These applications utilize the network's connectivity to collect, process, and transmit data, facilitating real-time decision-making and enhancing operational efficiency.

Furthermore, applications in a wireless mobility network are designed to be adaptive, taking advantage of the network's dynamic capabilities to optimize performance based on factors such as user location, device type, and network conditions. This adaptability ensures that applications can provide a seamless and high-quality user experience, even as network demands and conditions change.

Transport components in the wireless mobility network facilitate the transmission of data across various network segments. The transport components include technologies such as Ethernet, fiber optics, microwave links, and routers, each contributing to the movement of data packets within the network. Ethernet technology provides a method for local area network (LAN) connectivity, enabling data transfer between devices and network nodes. Fiber optics offer high-capacity and long-distance data transmission capabilities, utilizing light signals to achieve communication across extensive geographical areas. Microwave links serve as a wireless alternative for data transmission, particularly useful in scenarios where physical cabling is impractical, providing point-to-point connectivity over significant distances.

Routers direct data traffic between different network segments, ensuring that information reaches its intended destination. They manage data flow, optimize routing paths, and maintain network performance by adapting to changing network conditions. Additionally, routers can incorporate features such as load balancing and security protocols to enhance network reliability and protect against unauthorized access. Together, these transport components form the network infrastructure, supporting the delivery of services and applications to user devices. Their integration allows for scalable and flexible network architectures, capable of adapting to evolving technological demands and user requirements.

The mobile core in the wireless mobility network serves as the central part of the network architecture, managing the control and data traffic between user devices and external networks. It is responsible for key functions such as authentication, session management, mobility management, and data routing. The mobile core ensures that users can access network services seamlessly as they move across different geographical areas.

The mobile core of 4G networks includes various network elements such as the Mobility Management Entity (MME), Serving Gateway (SGW), and Packet Data Network Gateway (PGW) in LTE networks. These elements work together to handle signaling, manage user sessions, and route data packets to and from the internet or other external networks. Similarly, the mobile core of 5G networks includes several key network functions, such as Access and Mobility Management Function (AMF), Session Management Function (SMF), Service Communication Proxy (SCP), etc. In addition to these functions, the mobile core supports Quality of Service (QoS) management, ensuring that different types of data traffic receive the appropriate level of service based on their requirements.

The mobile core is also evolving to incorporate virtualization and cloud-based technologies, allowing for more flexible and scalable network architectures. This evolution supports the deployment of new services and applications, enabling operators to respond quickly to changing user demands and technological advancements.

In one or more embodiments, the system 200 is implemented as an AI-defined dynamic network. The system 200 utilizes a plurality of agentic AI agents distributed throughout the wireless mobility network. An agentic AI agent is an advanced form of artificial intelligence designed to autonomously make decisions, act, and pursue complex goals with limited supervision. Unlike traditional AI models that require constant human input, agentic AI systems can take initiative, understand context, and act independently. These agents are capable of sophisticated reasoning and iterative planning, allowing them to solve multi-step problems and adapt to dynamic environments. Agentic AI agents operate to perceive, reason, act, and learn. Agentic AI agents may gather information from their surroundings, analyze it to make informed decisions, execute actions based on those decisions, and continuously learn from the outcomes to improve future performance.

In wireless mobility networks including various network nodes depicted in FIG. 2A, agentic AI agents can be distributed across various network nodes, such as base stations, the mobile core, transport components, user equipment, etc. to collectively complete tasks. Agentic AI agents can dynamically assemble or configure network nodes based on service types, optimize resource allocation, and enhance network efficiency. This distributed approach allows agentic AI agents to interact with hardware and/or software in each network node and facilitate communications with other agentic AI agents in different network nodes.

Referring to FIG. 2A, the network nodes described above may not have to follow pre-defined static configuration. The network nodes are not statically connected. Rather the network nodes are arranged dynamically based on intent or service triggers driven by agentic AI agents. By way of example, the network nodes may serve as tools in a toolbox for agentic AI agents. The AI powered or AI driven dynamic network operates as a transformer to adapt to different scenarios and maximize both end user experience and network efficiency. In some embodiments, the line between the RAN, the transport component, and the mobile core may be blurred. Some of the network nodes may function as computing resources by agentic AI agents.

In various embodiments, the AI-defined dynamic network may assemble or configure network nodes based on service triggers such as events, services, security, latency, speed, etc. In some embodiments, agentic AI agents may be running in each network node. One or more agentic AI agents in one network node may communicate with agentic AI agents in other network nodes to coordinate actions in response to service triggers. Agentic AI agents may assemble necessary nodes to provide services.

FIG. 2B is a block diagram illustrating an example, non-limiting embodiment of a system 210 in accordance with various aspects described herein. The system 210 include a plurality of agentic AI agents 205 distributed in a wireless mobility network such as 5G communication networks. FIG. 2B illustrates an example embodiment of the system 210 within the 5G networks, showcasing the integration of agentic AI agents 205 across various network components. The system 210 includes user equipment (UE) 124, the Radio Access Network (RAN) labeled as 120, the User Plane Function (UPF) labeled as 158, and a Data Network (DN) labeled as 175, all interconnected through a control plane labeled as 125.

The 5G control plane 125 is responsible for managing signaling and control functions within the network, ensuring efficient communication and service delivery. The 5G control plane 125 includes several key network functions, each with specific roles. For instance, the Access and Mobility Management Function (AMF) handles user equipment registration, connection management, and mobility management, ensuring seamless connectivity as users move across different network areas. The Session Management Function (SMF) is responsible for session establishment, modification, and release. It manages IP address allocation and controls the data paths for user sessions. The Service Communication Proxy (SCP) acts as an intermediary for signaling messages between network functions, optimizing communication paths and enhancing network efficiency. These network functions work together within the control plane to manage user sessions, mobility, and service delivery, contributing to the overall performance and reliability of the 5G network. Other network functions perform their assigned functions according to the 3rd Generation Partnership Project (3GPP) specifications.

In the system 210, agentic AI agents 205 are distributed throughout the network, running in different network nodes such as the RAN 120 and the control plane 125. Additionally or alternatively, an agentic AI agent 207 may be arranged as a central agentic AI agent for coordinating actions among other AI agents distributed in different network nodes. The agentic AI agent 207 may be agnostic and operable independently of specific underlying technologies, platforms, or vendors. The agent AI agent 207 may support a wide range of devices, applications, and services without being tied to a particular hardware or software environment. The agent AI agent 207 may be device-agnostic, service-agnostic or both.

In some embodiments, the central agentic AI agent (e.g., the agent 207) may be the same or similar to other agentic AI agents distributed in specific network nodes, in terms of structures and functions thereof. Additionally or alternatively, the central agentic AI agent may have access to other network nodes and AI agents operating therein, which enables the central agentic AI agent 207 to have a broader view as to activities in the wireless mobility network, take more proactive actions and engage in determining actions that need to be taken.

In various embodiments, the agentic AI agents 205, 207 are configured to autonomously perform complex tasks and make decisions with minimal supervision. At their core, these agents 205, 207 utilize advanced machine learning models, such as neural networks, to process information and learn from data. Neural networks contain interconnected nodes, or neurons, organized in layers, which enable the agentic AI agents to recognize patterns, make predictions, and adapt to new information.

The architecture of agentic AI agents 205, 207 typically includes multiple layers, such as input layers for receiving data, hidden layers for processing and transforming data, and output layers for generating decisions or actions. These layers work together to simulate cognitive processes, allowing the agent to perceive its environment, reason about the information, act based on its analysis, and learn from the outcomes to improve future performance.

Additionally, agentic AI agents 205, 207 may incorporate reinforcement learning techniques, where they learn optimal behaviors through trial and error, receiving feedback in the form of rewards or penalties. This structure enables agentic AI agents 205, 207 to operate in dynamic environments, continuously refining their strategies to achieve specific goals. The structure of agentic AI agents 205, 207 can be adapted to specific fields primarily through the customization of their training processes and the selection of appropriate input data. While the core structure of neural networks may remain unchanged, adjustments can be made to an AI model's architecture, such as the number of layers or the type of activation functions, to better suit the complexity and nature of the tasks in a specific field such as the 5G networks.

In various embodiments, the agentic AI agents 205, 207 facilitate dynamic configuration and optimization of network resources based on service requirements and environmental conditions.

The RAN 120 connects the user equipment 124 to the core network, managing radio resources and ensuring efficient spectrum utilization. The UPF 158 handles data traffic routing between the RAN 120 and the data network 175, supporting various applications and services. The agentic AI agents 205 within these components work collaboratively to enhance network efficiency, adapt to changing demands, and provide high-quality user experience.

In various embodiments, the agentic AI agents 205, 207 in each network node within the 5G network are configured to manage resources and optimize network performance through dynamic resource allocation and the activation or deactivation of specific functions based on real-time needs. The agentic AI agents 205, 207 assess current network conditions and allocate resources efficiently by analyzing data such as user demand, network traffic, and environmental factors to determine the optimal distribution of resources across the network. Accordingly, the 5G network can handle varying loads and maintain high performance, even during peak usage times.

Based on real-time needs, the agentic AI agents 205, 207 can activate or deactivate specific network functions. For example, during a high-demand event, the agentic AI agents 205, 207 may activate additional bandwidth or processing power to accommodate increased traffic. Conversely, during periods of low demand, the agentic AI agents 205, 207 can deactivate certain functions to conserve energy and reduce operational costs. This flexibility allows the 5G network to adapt to changing conditions and maintain efficiency.

In various embodiments, the agentic AI agents 205, 207 distributed across different network nodes communicate with each other to coordinate actions and perform necessary network activities. The communication enables the agentic AI agents 205, 207 to share information about network status, resource availability, and user requirements. By collaborating, the agentic AI agents 205, 207 can make informed decisions that may benefit the entire network, such as rerouting traffic to avoid congestion or prioritizing critical services. Through interactions, the agentic AI agents 205, 207 can collectively manage complex network tasks, such as load balancing, fault detection, and recovery. For instance, if a particular node experiences a failure, the agentic AI agents 205, 207 in neighboring nodes can quickly reallocate resources and reroute traffic to maintain service continuity. This distributed approach may enhance the network's resilience and responsiveness.

FIG. 2C depicts an illustrative embodiment of a method in accordance with various aspects described herein. In various embodiments, the method 220 includes facilitating communications among agentic artificial intelligence (AI) agents running in network nodes in a wireless mobility network (Step 222). The facilitation of communications among agentic AI agents further involves facilitating communications between a centralized agentic AI agent and individual agentic AI agents running in respective network nodes. The method 220 further includes, with the agentic AI agents, configuring one or more of the network nodes based on a service trigger (Step 224). The service trigger includes an event, security, latency, speed, or a combination thereof, which is related to network services in the wireless mobility network. The network nodes include user equipment, a radio access network (RAN), a mobile core network, a transport system, or a combination thereof. The method 220 includes coordinating an action responsive to the service trigger via the communications among the agentic AI agents (Step 226).

In various embodiments, the method 220 further includes dynamically assembling a necessary network node in the wireless mobility network by communicating with an agentic AI agent running the necessary network node to allocate a network resource and activate a first set of functions while deactivating a second set of functions. The method 220 also includes expanding or reducing the number of network nodes based on the service trigger, which requires increased or decreased network traffic, low latency requirements of network services, or a combination thereof.

In some embodiments, a service trigger indicates a particular type of service, and the configuration of the network nodes involves allocating more or less bandwidth to meet the requirements of the particular type of service, activating a set of functions related to the particular type of service, deactivating another set of functions that are not needed for the particular type of service, or a combination thereof. In other embodiments, the service trigger indicates a particular type of network device, and the configuration of the network nodes involves activating a set of functions related to the particular type of network device and deactivating another set of functions that are not desirable for the particular type of network device. As one example, the particular type of network device includes an Internet of Things (IoT) device, and the activated set of functions with the agentic AI agents includes communicating with the IoT device solely on a need basis and at a minimum speed. As another example, the particular type of network device includes a fixed wireless access (FWA) device, and the deactivated set of functions with the agentic AI agents includes mobility functions.

FIG. 2D depicts an illustrative embodiment of another method 230 in accordance with various aspects described herein. The method 230, as illustrated in FIG. 2D, includes a series of steps for dynamically managing network nodes, using agentic AI agents, in response to service requests within a wireless mobility network. The method 230 includes receiving a service request and detecting a service type (Step 232). For instance, the service request includes a service type such as Enhanced Mobile Broadband (eMBB), which is designed to provide significantly improved data rates and capacity compared to previous generations of mobile networks. The service type, eMBB focuses on delivering high-speed internet access and supporting data-intensive applications, such as high-definition video streaming, virtual reality, and augmented reality, on mobile devices. As a service, the eMBB aims to enhance the user experience by providing faster download and upload speeds, greater network capacity, and improved coverage, especially in densely populated areas like urban centers, stadiums, and transportation hubs. It supports seamless connectivity and high-quality service for users who require substantial bandwidth and low latency for their applications. The implementation of eMBB thus may involve advancements in network infrastructure, including the deployment of more base stations, the use of higher frequency bands, and the integration of technologies such as massive MIMO (Multiple Input Multiple Output) and beamforming. These enhancements enable eMBB to meet the growing demand for mobile data and support a wide range of applications that require robust and reliable connectivity.

Upon identifying the service type, the method 230 proceeds to dynamically configure network nodes based on the service type (Step 234). This involves configuring the network to optimize resource allocation and performance tailored to the specific service requirements based on the service type. For instance, where the service type is the eMBB, a UE such as a mobile device sends a service request, an agentic AI agent in a RAN node detects the eMBB as the service type and turns on RAN functions that are related to the eMBB such as a high throughput, a handover, voice, etc. In light of the service type and requirements in the eMBB, more agentic AI agents in more RAN nodes may be triggered and configure RAN modes to allocate more bandwidth and modify scheduling for the eMBB service.

Following the configuration of network nodes, the method 230 includes selectively activating and deactivating network functions based on the service type (Step 236). This step ensures that only the necessary functions are operational, conserving energy and resources by deactivating functions that are not required for the current service. The method further includes communicating with other agentic AI agents in other network nodes to take actions based on the service type (Step 238). This communication facilitates coordination among distributed agents, enabling them to collectively manage network activities and optimize service delivery. For instance, the agentic AI agent in the RAN communicates with agentic AI agents in a transport and a mobile core network to provision corresponding functions for the eMBB.

Once the service is completed, the method 230 includes rolling back a change made for the action by the agentic AI agents, such as resetting or returning resources and functions to an initial state (Step 239). This step resets the network configuration, preparing it for subsequent service requests and maintaining overall network efficiency. The method 230, as depicted in FIG. 2D, demonstrates a structured approach to leveraging agentic AI agents for dynamic network management, enhancing service delivery and resource utilization in the wireless mobility network such as the 5G networks.

Another service request includes a service type such as communications with Internet of Things (IoT) devices. The method 230 facilitates the agentic AI agents, which manage network resources dynamically to support IoT devices within the wireless mobility network. The process begins with receiving a service request from an IoT device, such as a wearable, sensor, shipment tracking, or smart home appliance, and detecting the service type (Step 232). Upon identifying the service type as IoT, the method 230 proceeds to dynamically configure network nodes tailored to the specific requirements of IoT services (Step 234). This involves configuring the network to optimize resource allocation using the agentic AI agents, focusing on low data rates and power-saving measures to extend battery life for IoT devices. For instance, the agentic AI agent in a RAN node and a mobile core may set up communications with an IoT device to be performed at a minimum speed and at a prolonged interval or only when needed (such as when receiving an activation signal from the IoT device).

Following the configuration of network nodes, the method 230 includes selectively activating and deactivating network functions based on the IoT service type (Step 236). For instance, only the necessary functions for IoT communication are activated, while other functions remain inactive to conserve energy and resources. The method 230 further includes communicating with other agentic AI agents in different network nodes to coordinate actions based on the IoT service type (Step 238). This communication ensures that the network can efficiently handle IoT data transmission and processing, facilitating real-time monitoring and automation. By way of example, an IoT device is a fire alarm sensor and sends a signal to the network. The agentic AI agents in the RAN node and/or the mobile core identify the signal from the fire alarm sensor and configure the nodes to escalate a response speed, unlike typical IoT communications performed at a minimum speed. Moreover, the agentic AI agents communicate with agents in other nodes including an agentic AI agent in other emergency service systems such as Enhanced 911(E911 ). E911 is an advanced emergency response system designed to provide more accurate location information for emergency calls made from mobile devices. Unlike traditional 911 services, which primarily rely on the caller's verbal description of their location, E911 automatically transmits the caller's location data to emergency responders, enabling quicker and more precise dispatch of assistance.

Once the IoT service is completed, the method 230 includes returning resources and functions to an initial state (Step 239). This step resets the network configuration, preparing it for subsequent service requests and maintaining overall network efficiency.

As an additional example, the method 230 can be implemented to support Fixed Wireless Access (FWA) services. FWA provides high-speed internet connectivity to fixed locations, such as homes or businesses, using wireless technology instead of traditional wired connections. The method 230 begins with receiving a service request from an FWA user equipment (UE) and detecting the service type as FWA. Upon identifying the service type, agentic AI agents dynamically configure network nodes to optimize resource allocation specifically for FWA services. This includes configuring the network to prioritize high-speed data transmission while minimizing mobility functions, as FWA users typically remain in fixed locations (Step 234). Agentic AI agents selectively activate and deactivate network functions based on the FWA service type (Step 236). For instance, mobility-related functions are deactivated to conserve resources, while functions that enhance data throughput and stability are activated to ensure reliable service delivery. The agentic AI agents communicate with other agents in different network nodes, such as the RAN and core network, to coordinate actions and maintain efficient service delivery tailored to FWA requirements (Step 238).

Once the FWA service is completed or adjusted, the method 230 includes returning resources and functions to an initial state, provisioning the network for subsequent service requests (Step 239). This embodiment demonstrates the role of agentic AI agents in optimizing network operations for FWA services, ensuring efficient resource utilization and high-quality service delivery while maintaining energy savings.

FIG. 2E depicts an illustrative embodiment of another method 240 in accordance with various aspects described herein. FIG. 2E illustrates the method 240 including a centralized agentic AI agent, which contrasts with the distributed agentic AI agents described in FIG. 2D. The centralized agentic AI agent has a broader view than an individual agentic AI agent distributed in each network node. The method 240 includes receiving monitoring and reporting to the network from an agentic AI agent in an individual network node (Step 242). This step enables the centralized agentic AI agent to continuously observe network conditions and gathering data to identify potential service needs. As one example, a user is moving away from a city where base stations are densely distributed and provide good access to the mobility network. A mobile device of the user is moving away from the city and into a sparsely populated area such as a dessert area or a mountain area. An agentic AI agent in the mobile device of the user monitors and detects location changes and trajectories and reports to the network.

The method 240 includes detecting a service need by a centralized agentic AI agent (Step 244). Using the above example, the centralized agentic AI agent receives the monitoring and reporting from the agentic AI agent in the mobile device of the user. Then the centralized agentic AI agent has a coverage view and detects that the mobile device of the user is going to lose mobility coverage (Step 244). Upon detecting a service need (Step 244), the centralized agentic AI agent determines an action to be taken based on the service need (Step 246). This involves analyzing the gathered data to decide on the optimal network configuration and resource allocation required to address the identified service need. For instance, the centralized AI agent determines that as the mobile device of the user moves into the dessert area, a mobility coverage of the mobile device will be lost. The centralized AI agent then determines an alternative coverage to the mobility coverage and contacts an agentic AI agent in a satellite node.

The method 240 further includes communicating with other agentic AI agents in other network nodes to take actions based on the service need (Step 248). This communication ensures that the centralized agentic AI agent can coordinate with distributed agents to implement the necessary network adjustments and optimize service delivery. For instance, the centralized agent will contact the agentic AI agent in the satellite node and enable the satellite connection for the mobile device of the user as a backup connection.

Finally, the method 240 involves coordinating actions with other agentic AI agents (Step 249). This step allows the centralized agentic AI agent to oversee and synchronize the activities of distributed agents, ensuring a cohesive and efficient response to the service need. For instance, once the user is out of coverage of mobility networks, its connection is transferring to satellite seamlessly such that the mobile device of the user stays connected while the user is moving away from the city. As depicted in FIG. 2E, the method 240 demonstrates the functions of the centralized agentic AI agent in managing network activities, highlighting its ability to oversee and coordinate distributed agents to enhance network performance, service delivery and user experience in the wireless mobility networks.

While for purposes of simplicity of explanation, the respective processes are shown and described as a series of blocks in FIGS. 2C-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above-described embodiments, the AI driven dynamic network may significantly change the mobility network, bring AI powered automation, flexibility of services, and cost savings to businesses. AI powered dynamic network will adapt quickly to different new services, and run on commercial off the shelf hardware (COTS HW) over specialized and/to customized hardware.

The network nodes are not statically connected. They can be arranged dynamically based on intent/triggers, driven by the agentic AI agents distributed in one or more network nodes and/or by the centralized agentic AI agent. The network nodes are tools in the toolbox for AI. AI powered dynamic network work like a transformer to adapt to different scenarios and maximize both end user experience and network efficiency. The line between the RAN, the transport component, and the mobile core are blurred. From AI perspective, it is the compute resources. For example, in disaster scenarios, the network can automatically expand the capacity to form a minimum path between end users and applications. In a stadium/entertainment event, the network nodes will be formed to focus on high quality video delivery, etc.

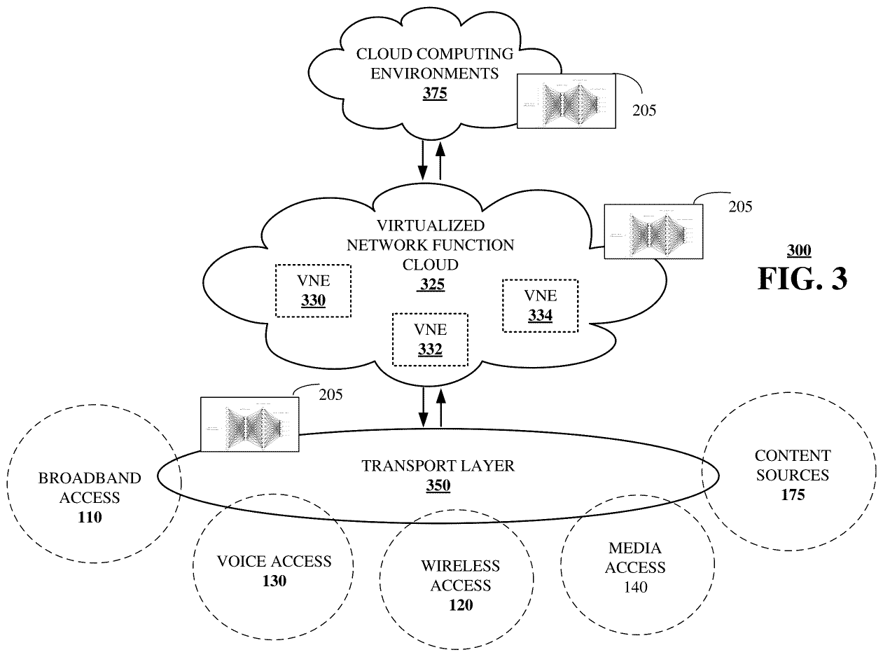

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, 210, and methods 230, 240 presented in FIGS. 1, 2A~2D, and 3. For example, virtualized communication network 300 can facilitate in whole or in part systems and methods facilitating artificial intelligence (AI) driven dynamic configuration of network nodes in mobility networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

In various embodiments, the one or more agentic artificial intelligence (AI) agents 205 are distributed in the system 300. As depicted in FIG. 3, the agentic AI agents 205 are arranged in the virtualized network function cloud 325 which can communicate with other agentic AI agents arranged in other elements of the virtualized network function cloud 325. For instance, the agentic AI agents 205 can be arranged and used in the cloud computing environments 375, the transport layer 350, the wireless access 120, the voice access 130, the media access 140 and/or the distribution of content from content sources 175.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

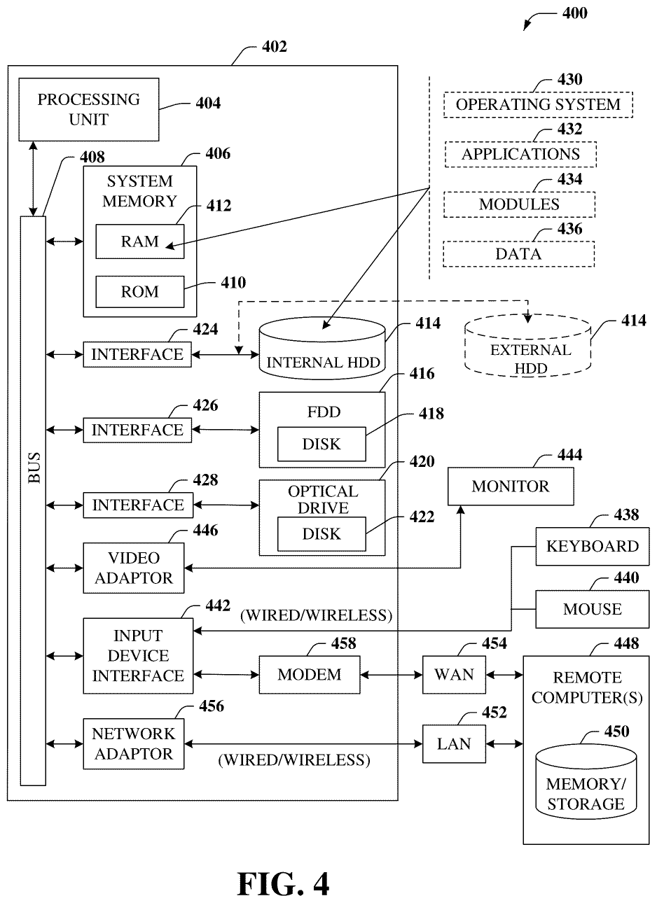

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating artificial intelligence (AI) driven dynamic configuration of network nodes in mobility networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

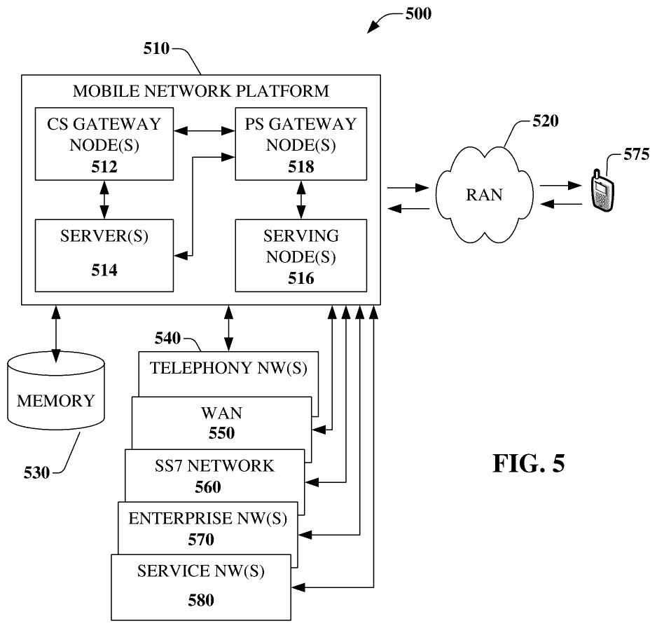

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating artificial intelligence (AI) driven dynamic configuration of network nodes in mobility networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

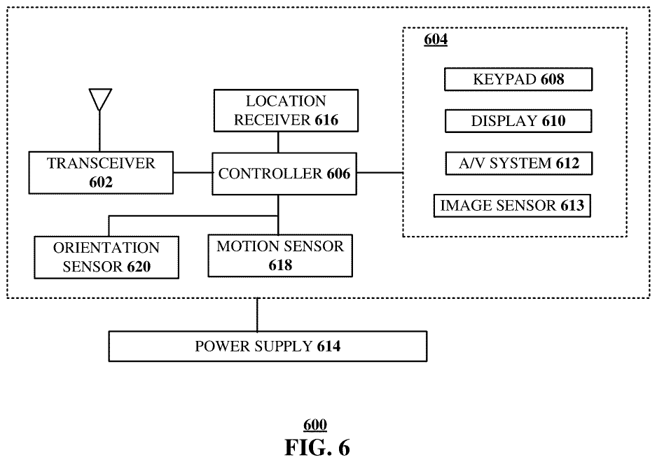

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating artificial intelligence (AI) driven dynamic configuration of network nodes in mobility networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor; and
a memory that stores executable instructions that, when executed by the processing system, facilitate performance of operations, the operations comprising:
facilitating communications among agentic artificial intelligence (AI) agents running in network nodes in a wireless mobility network;
with the agentic AI agents, configuring one or more of the network nodes based on a service trigger, wherein the network nodes include user equipment, a radio access network (RAN), a mobile core network, a transport system, or a combination thereof; and
coordinating an action responsive to the service trigger via the communications among the agentic AI agents.

2. The system of claim 1, wherein the service trigger includes an event, a security, a latency, a speed or a combination thereof, which is related to network services in the wireless mobility network.

3. The system of claim 1, wherein the operations further comprise dynamically assembling a necessary network node in the wireless mobility network by communicating with an agentic AI agent running the necessary network node to allocate a network resource and activate a first set of functions and deactivate a second set of functions.

4. The system of claim 1, wherein the operations further comprise expanding or reducing a number of network nodes based on the service trigger, wherein the service trigger requires increased or decreased network traffic, low latency requirements of network services or a combination thereof.

5. The system of claim 1, wherein the service trigger is indicative of a particular type of service, and the configuring the network nodes further comprises, with the agentic AI agents running in the network nodes, allocating more or less bandwidth to meet requirements of the particular type of service, activating a set of functions relating to the particular type of service, deactivating another set of functions that are not needed for the particular type of service, or a combination thereof.

6. The system of claim 1, wherein the service trigger is indicative of a particular type of network device, and the configuring the network nodes further comprises, with the agentic AI agents running in the network nodes, activating a set of functions relating to the particular type of network device and deactivating another set of functions that are not desirable for the particular type of network device.

7. The system of claim 6, wherein the particular type of network device includes an Internet of Thing (IoT) device and the activated set of functions with the agentic AI agents includes communicating with the IoT device solely on a need basis and at a minimum speed.

8. The system of claim 6, wherein the particular type of network device includes a fixed wireless access (FWA) device and the deactivated another set of functions with the agentic AI agents includes mobility function.

9. The system of claim 1, wherein the facilitating communications among agentic AI agents further comprise facilitating communications between a centralized agentic AI agent and individual agentic AI agents running in respective network nodes.

10. A non-transitory machine-readable medium, comprising executable instructions that, when executed by a processing system including a processor, facilitate performance of operations, the operations comprising:
facilitating communications among agentic artificial intelligence (AI) agents in one or more network nodes in a wireless mobility network;
receiving a service request and detecting a service type associated with the service request;
with the agentic AI agents, dynamically assembling or configuring the one or more network nodes in the wireless mobility network based on the detected service type;
coordinating an action based on the detected service type via the communications among the agentic AI agents; and
upon completion of the action, rolling back a change made for the action by the agentic AI agents.

11. The non-transitory machine-readable medium of claim 10, wherein the operations further comprise:
in response to the detected service type, with each agentic AI agent running in the one or more network nodes:
allocating a first network resource to meet service requirements of the detected service type; and
selectively activating and deactivating network functions to comply with the service requirements of the detected service type.

12. The non-transitory machine-readable medium of claim 10, wherein the dynamically assembling or configuring further comprises configuring the one or more network nodes in the wireless mobility network to:
adjust bandwidth allocation among the one or more network nodes based on the detected service type to ensure optimal data transmission rates;
implement security protocols tailored to the detected service type to protect data integrity and privacy during service delivery; and
adjust a communication interval and a communication speed to save power for a long battery life, or a combination thereof.

13. The non-transitory machine-readable medium of claim 10, wherein the dynamically assembling or configuring further comprises adding another network node that provides a different network resource and a different service in the wireless mobility network.

14. The non-transitory machine-readable medium of claim 13, wherein the facilitating communications among agentic AI agents further comprise facilitating communications between a centralized agentic AI agent and an individual agentic AI agent running in the added another network node to provision the different network resource and the different service.

15. A method, comprising:
dynamically configuring, by a processing system including a processor of an agentic artificial intelligence (AI) agent, a network node in a wireless mobility network based on a service request, wherein the network nodes include user equipment, a radio access network (RAN), a mobile core network, a transport system, or a combination thereof;
facilitating, by the processing system, communications with other agentic artificial intelligence (AI) agents running in different network nodes in the wireless mobility network; and
coordinating, by the processing system, a first action responsive to the service request via the communications with the other agentic AI agents.

16. The method of claim 15, further comprising:
receiving, by the processing system, monitoring and reporting information for the wireless mobility network, wherein the monitoring and the reporting information include network conditions and mobility service data;
detecting, by the processing system, a service need based on the monitoring and the reporting information;
determining, by the processing system, a second action to be taken based on the service need; and
coordinating, by the processing system, the second action responsive to the service need via the communications among the agentic AI agents.

17. The method of claim 16, further comprising facilitating, by the processing system, addition of one or more network nodes to carry out the first action or the second action.

18. The method of claim 17, wherein the service need is to provide an alternative coverage to a mobility coverage and the addition of the one or more network nodes further comprises adding one or more alternative mobility nodes to a cellular mobility node.

19. The method of claim 16, wherein the receiving further comprises receiving the monitoring and the reporting information at the processing system of a centralized agentic AI agent and the facilitating communications further comprises facilitating communications between the centralized agentic AI agent and the agentic AI agents in individual network nodes, wherein the centralized agentic AI agent is agnostic to the individual network nodes and accesses a set of information that is not accessible at the individual network nodes.

20. The method of claim 15, wherein the service request is indicative of a particular type of service, a particular type of network device, and
wherein the dynamically configuring the network node further comprises allocating more or less bandwidth to meet requirements of the particular type of service, activating a set of functions relating to the particular type of service or the particular type of network device, deactivating another set of functions that are not needed for the particular type of service or the particular type of network device, or a combination thereof.
